(19) United States
(12) Patent Application Publication
(10) Pub. No.: US 2022/0300927 A1
(43) Pub. Date: Sep. 22, 2022

(54) CONTROL APPARATUS, SYSTEM, AND CONTROL METHOD

(71) Applicant: TOYOTA JIDOSHA KABUSHIKI KAISHA, Toyota-shi (JP)

(72) Inventors: Kodai TAKANOHASHI, Okazaki-shi (JP); Atsushi OKUBO, Nisshin-shi (JP); Yuji TACHIBANA, Nisshin-shi (JP); Shogo MOMOSHIMA, Nagoya-shi (JP); Takaaki KATO, Saitama-shi (JP); Daiki KANEICHI, Tokyo (JP); Minoru NAKADORI, Toyota-shi (JP)

(21) Appl. No.: 17/653,830

(22) Filed: Mar. 7, 2022

(30) Foreign Application Priority Data
Mar. 17, 2021 (JP) 2021-044043

(51) Int. Cl. G06Q 20/14; G07C 5/00; B60L 53/66

(52) U.S. Cl. CPC G06Q 20/14; G07C 5/008; B60L 53/665; G06Q 2240/00

(57) ABSTRACT

A control apparatus includes a communication unit configured to communicate with a vehicle, and a control unit configured to acquire vehicle information indicating attributes of the vehicle via the communication unit, set a use fee for each of a plurality of parking spaces in a parking lot based on the acquired vehicle information, and transmit, via the communication unit, fee information indicating the set use fee to the vehicle.

### CROSS-REFERENCE TO RELATED APPLICATION

This application claims priority to Japanese Patent Application No. 2021-044043 filed on Mar. 17, 2021, incorporated herein by reference in its entirety.

### BACKGROUND

### 1. Technical Field

The present disclosure relates to a control apparatus, a system, and a control method.

### 2. Description of Related Art

There is a well-known technology that increases the effect of attracting customers to a parking lot by changing its use fees to improve its profitability. Japanese Unexamined Patent Application Publication No. 2016-045806 (JP 2016-045806 A) discloses a parking lot reservation system that predicts parking demand for a parking lot for each time range and sets a use fee for each time range thereof based on the predicted parking demand.

### SUMMARY

In the technology described in JP 2016-045806 A, efficient use of a parking space is not promoted.

The present disclosure provides a technology that promotes efficient use of a parking space.

A control apparatus according to a first aspect of the present disclosure includes a communication unit configured to communicate with a vehicle, and a control unit configured to acquire, via the communication unit, vehicle information indicating attributes of the vehicle, set a use fee for each of a plurality of parking spaces in a parking lot based on the acquired vehicle information, and transmit, via the communication unit, fee information indicating the set use fee to the vehicle.

In the first aspect, the vehicle may be driven by a driver and the attributes of the vehicle may include a level of the driver's parking skill.

In the first aspect, the control unit may be configured to set, when the level of the driver's parking skill indicated by the vehicle information is equal to or higher than a threshold value, the use fee according to a parking difficulty degree evaluated for each of the parking spaces.

In the first aspect, the control unit may be configured to set, when the level of the driver's parking skill is equal to or higher than the threshold value, the use fee to be lower as the parking difficulty degree is higher.

In the first aspect, the control unit may be configured to select, according to the level of the driver's parking skill, at least one parking space from among the parking spaces and transmit, via the communication unit, information prompting parking at the selected parking space to the vehicle.

In the first aspect, the control unit may be configured to select, as the at least one parking space, a parking space of which the parking difficulty degree is higher as the level of the driver's parking skill is higher.

In the first aspect, the attributes of the vehicle may include a kind of vehicle classified by an energy source used by the vehicle.

In the first aspect, at least one of the parking spaces may be provided with a supply facility that supplies a first energy source. The control unit may be configured to set, when the kind of vehicle indicated by the vehicle information is a kind that uses a second energy source, the use fee according to whether the supply facility is provided. The second energy source is different from the first energy source.

In the first aspect, the control unit may be configured to set, when the kind of vehicle is the kind that uses the second energy source, a use fee of a parking space provided with the supply facility to be higher than a use fee of a parking space not provided with the supply facility.

In the first aspect, the control unit may be configured to select, according to the kind of vehicle, at least one parking space from among the parking spaces and transmit, via the communication unit, information prompting parking at the selected parking space to the vehicle.

In the first aspect, the control unit may be configured to select, when the kind of vehicle is the kind that uses the second energy source, as the at least one parking space, a parking space not provided with the supply facility.

A system according to a second aspect of the present disclosure includes the control apparatus and a vehicle configured to communicate with the control apparatus.

A control method according to a third aspect of the present disclosure includes communicating, by a control apparatus, with a vehicle, acquiring, by the control apparatus, vehicle information indicating attributes of the vehicle, setting, by the control apparatus, a use fee for each of a plurality of parking spaces in a parking lot based on the acquired vehicle information, and transmitting, by the control apparatus, fee information indicating the set use fee to the vehicle.

In the third aspect, the vehicle may be driven by a driver and the attributes of the vehicle may include a level of the driver's parking skill.

In the third aspect, setting the use fee may include setting, when the level of the driver's parking skill indicated by the vehicle information is equal to or higher than a threshold value, the use fee according to a parking difficulty degree evaluated for the each of the parking spaces.

In the third aspect, setting the use fee may include setting, when the level of the driver's parking skill is equal to or higher than the threshold value, the use fee to be lower as the parking difficulty degree is higher.

In the third aspect, the control method may further include selecting, by the control apparatus, according to the level of the driver's parking skill, at least one parking space from among the parking spaces and transmitting, from the control apparatus, information prompting parking at the selected parking space to the vehicle.

In the third aspect, the attributes of the vehicle may include a kind of vehicle classified by an energy source used by the vehicle.

In the third aspect, at least one of the parking spaces may be provided with a supply facility that supplies a first energy source. Setting the use fee may include setting, when the kind of vehicle indicated by the vehicle information is a kind that uses a second energy source, the use fee according to whether the supply facility is provided. The second energy source is different from the first energy source.

In the third aspect, setting the use fee may include setting, when the kind of vehicle is the kind that uses the second energy source, a use fee of a parking space provided with the supply facility to be higher than a use fee of a parking space not provided with the supply facility.

With each aspect of the present disclosure, it is possible to promote the efficient use of a parking space.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to an embodiment of the present disclosure;

FIG. 2 is a diagram illustrating an example of a parking lot according to an embodiment of the present disclosure;

FIG. 3 is a diagram illustrating an example of a table in which evaluation results of parking difficulty degrees are stored according to an embodiment of the present disclosure;

FIG. 4 is a block diagram illustrating a configuration of a control apparatus according to an embodiment of the present disclosure;

FIG. 5 is a block diagram illustrating a configuration of a vehicle according to an embodiment of the present disclosure; and

FIG. 6 is a flowchart illustrating an operation of a system according to an embodiment of the present disclosure.

### DETAILED DESCRIPTION OF EMBODIMENTS

Hereinafter, one embodiment of the present disclosure will be described with reference to drawings.

In each drawing, same or corresponding parts are designated by same reference signs. In the present embodiment, description thereof will be omitted or simplified as appropriate for the same or corresponding parts.

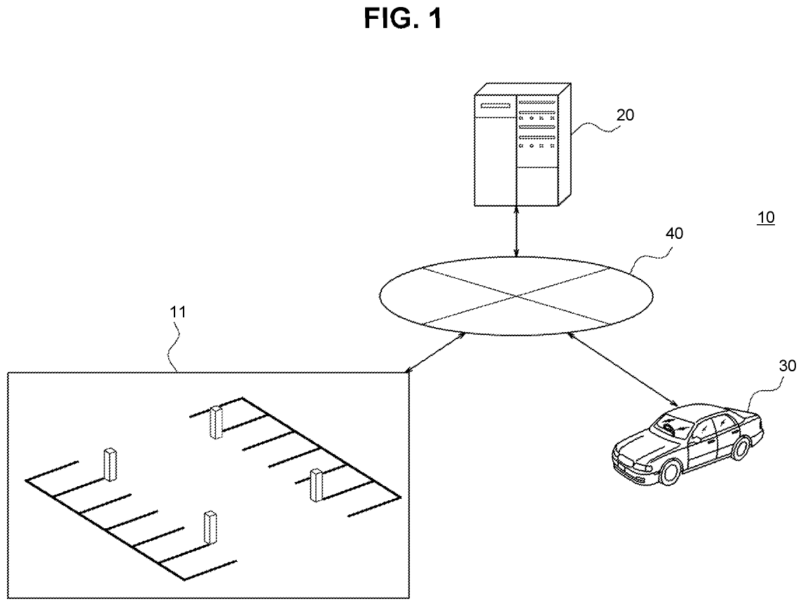

A configuration of a system 10 according to the present embodiment will be described with reference to FIG. 1.

The system 10 according to the present embodiment includes at least one control apparatus 20 and at least one vehicle 30.

The control apparatus 20 can communicate with the vehicle 30 via a network 40.

The network 40 includes the Internet, at least one wide area network (WAN), at least one metropolitan area network (MAN), or a combination thereof. The network 40 may include at least one wireless network, at least one optical network, or a combination thereof. Examples of the wireless network include an ad-hoc network, a cellular network, a wireless local area network (LAN), a satellite communication network, or a terrestrial microwave network.

The control apparatus 20 is installed in a facility, such as a data center. The control apparatus 20 may be a computer, such as a server belonging to a cloud computing system or other computing systems.

Examples of the vehicle 30 include any type of vehicle, such as a gasoline vehicle, a diesel vehicle, a hybrid vehicle (HV), a plug-in hybrid vehicle (PHV), an electric vehicle (EV), or a fuel cell vehicle (FCV). In the present embodiment, the vehicle 30 is driven by a driver, but it may be driven at any level of automation or may be an autonomous vehicle (AV). The level of automation may be, for example, one of Levels 1 to 5 classified by the Society of Automotive Engineers (SAE) leveling. The vehicle 30 may be a vehicle dedicated to Mobility-as-a-Service (MaaS).

An overview of the present embodiment will be described with reference to FIGS. 1, 2, and 3.

Generally, there is a parking space at which parking is difficult in a parking lot. For example, parking is difficult at a parking space at which a pillar is installed at an entrance thereof such that a width of the entrance is narrow, and at a parking space at which another vehicle is already parked in an adjacent parking space.

Demand is concentrated on a highly convenient parking space in a parking lot. Specifically, a parking space at which parking is easy is more convenient than a parking space at which parking is difficult, and thus demand is concentrated on the parking space at which parking is easy. As a result of the concentration of demand for the parking space at which parking is easy, it is not possible for a driver with a low level of parking skill to park at a parking space at which parking is difficult even when the parking space at which parking is difficult is empty. Consequently, the parking space at which parking is difficult is not used and is wasted. Further, when a driver with a low level of parking skill waits in an aisle in the parking lot until a parking space at which parking is easy becomes empty, the aisle is blocked and congestion occurs in the parking lot. Further, even when a driver with a low level of parking skill tries to park at a parking space at which parking is difficult, the parking operation may take time due to trial and error, such as repeated turning of a steering wheel. In such a case, while the driver is trying to park by trial and error, other vehicles are obstructed from passing and congestion occurs in the parking lot. As such, congestion may also occur in the parking lot caused by the concentration of demand for a highly convenient parking space.

Therefore, for example, when a vehicle can be guided to a parking space according to a level of a driver's parking skill, efficient use of a parking space is promoted. For example, when a vehicle driven by a driver with a high level of parking skill can be guided to a parking space at which parking is difficult and a vehicle driven by a driver with a low level of parking skill can be guided to a parking space at which parking is easy, the number of parking spaces that remain empty without being used for parking is reduced. Therefore, efficient use of a parking space is promoted.

In the system 10 according to the present embodiment, the control apparatus 20 communicates with the vehicle 30 and acquires vehicle information D1 indicating attributes of the vehicle 30. The control apparatus 20 sets a use fee for each of a plurality of parking spaces in a parking lot 11 based on the acquired vehicle information D1. The control apparatus 20 transmits fee information D2 indicating the set use fee to the vehicle 30.

With the present embodiment, it is possible to set a use fee for each parking space according to the attributes of the vehicle 30. By setting a use fee of a parking space suitable for the attributes of the vehicle 30 to be low, it is possible to guide the vehicle 30 to the parking space. In the present embodiment, the attributes of the vehicle 30 include a level of parking skill of a driver of the vehicle 30. When the level of parking skill of the driver of the vehicle 30 is high and a fee of a parking space at which parking is difficult is set to be low, the driver with a high level of parking skill will be incentivized to park at a parking space at which parking is difficult. Thus, the vehicle 30 is guided to a parking space at which parking is difficult. Therefore, the use of a parking space at which parking is difficult is promoted. As a result, the concentration of demand for a highly convenient parking space at which parking is easy is restricted, and congestion in the parking lot is alleviated.

In the present embodiment, the parking lot 11 has a plurality of parking spaces. The parking lot 11 is a flat parking lot, but is not limited thereto and may be any parking lot, such as an underground parking lot or a multi-story parking lot with two or more floors, as long as the parking space at which the vehicle 30 is parked is arbitrarily selected. When a driver uses the parking lot 11, a use fee is incurred for each parking space. A use fee of the parking lot 11 may be settled at a time of entering/leaving the parking lot or at a gate where the entry/exit to/from the parking lot 11 is executed.

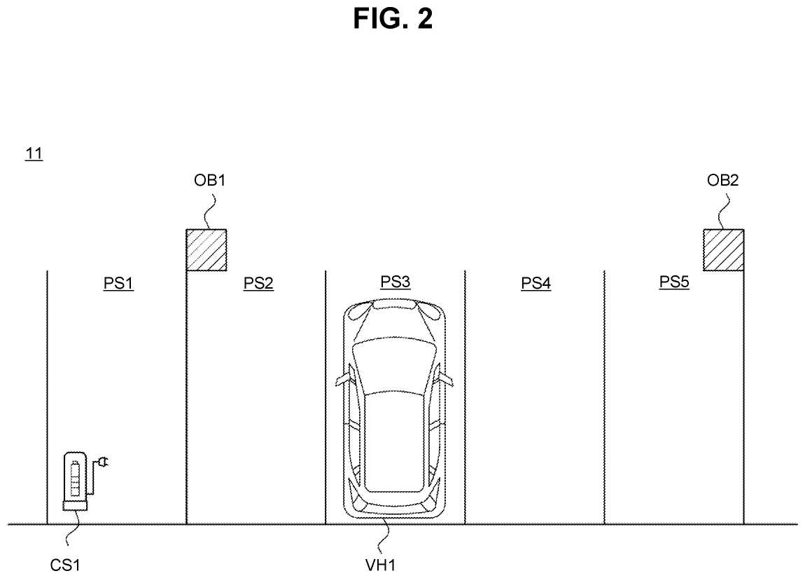

FIG. 2 illustrates an example of the parking lot 11 of the present embodiment.

In an example of FIG. 2, five parking spaces PS1, PS2, PS3, PS4, PS5 are illustrated as a plurality of parking spaces in the parking lot 11. The number of parking spaces in the parking lot 11 is not limited to five, and can be any number of two or more according to a size of the parking lot 11. An obstacle OB1 is present at an entrance of the parking space PS2. An obstacle OB2 is present at an entrance of the parking space PS5. In the present embodiment, the obstacle OB1 and the obstacle OB2 are pillars, but are not limited thereto and may be any objects, such as trees, as long as the widths of the entrances are narrow due to the obstacles. The number and positions of the obstacles are not limited to the above, and may be arbitrarily determined. The parking space PS1 is provided with a supply facility CS that supplies an energy source that can be used by the vehicle 30. In this example, the supply facility CS is a charging facility CS1 for an EV. The number of parking spaces at which supply facilities CS are installed is not limited to one, and two or more parking spaces may be provided with supply facilities CS, respectively. A vehicle VH different from the vehicle 30 is already parked at the parking space PS3. The number of parking spaces at which vehicles VH are parked is not limited to one, and one vehicle VH may be parked at each of two or more parking spaces.

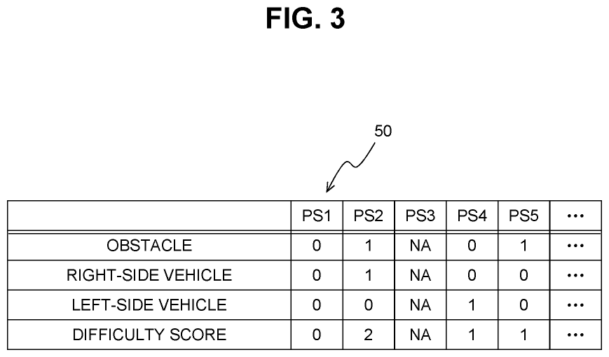

FIG. 3 illustrates a table 50 as an example of a table that stores evaluation results of parking difficulty degrees. The parking difficulty degree is evaluated for each of the plurality of parking spaces. The table 50 stores a parking difficulty degree for each of the parking spaces PS1 to PS5 in the parking lot 11 illustrated in FIG. 2.

The parking difficulty degree may be evaluated in any procedures, but in the present embodiment, it is evaluated based on, as evaluation items, the presence/absence of an obstacle in a parking space, which is an evaluation target, and the presence/absence of a vehicle parked at an adjacent parking space. Specifically, the evaluation results illustrated in the table 50 of FIG. 3 are as follows. In other words, when the parking space PS1 is an evaluation target, no obstacle is present and no vehicle is present at any of adjacent parking spaces on its right side and left side. Thus, 0 points are added in the evaluation item of an obstacle, 0 points are added in the evaluation item of a right-side vehicle, and 0 points are added in the evaluation item of a left-side vehicle. Therefore, a difficulty score of the parking space PS1 is 0 points. When the parking space PS2 is an evaluation target, the obstacle OB1 is present and a vehicle VH is present at an adjacent parking space on its right side. Thus, 1 point is added in the evaluation item of an obstacle and 1 point is added in the evaluation item of a right-side vehicle. Therefore, a difficulty score of the parking space PS2 is 2 points. Since the vehicle VH different from the vehicle 30 is already parked at the parking space PS3, it is not evaluated. When the parking space PS4 is an evaluation target, no obstacle is present and the vehicle VH is present at the adjacent parking space on its left side. Thus, 0 points are added in the evaluation item of an obstacle and 1 point is added in the evaluation item of a left-side vehicle. Therefore, a difficulty score of the parking space PS4 is 1 point. When the parking space PS5 is an evaluation target, an obstacle is present but no vehicle is present at any of adjacent parking spaces on its right side and left side. Thus, 1 point is added in the evaluation item of an obstacle, 0 points are added in both the evaluation item of a right-side vehicle and the evaluation item of a left-side vehicle. Therefore, a difficulty score of the parking space PS5 is 1 point.

The example of FIG. 3 illustrates that the parking difficulty degree is higher as the difficulty score is higher. Specifically, in the example of FIG. 3, the parking space PS2 with the difficulty score of 2 has the highest parking difficulty degree from among the parking spaces PS1 to PS5. The parking difficulty degree of the parking spaces PS4 and PS5 is lower than that of the parking space PS2 and higher than that of the parking space PS1. The parking difficulty degree of the parking space PS1 is the lowest. In the present embodiment, the parking difficulty degree is calculated by a score, but it may be calculated by any method, such as a grade evaluation or an evaluation function.

A level of a driver's parking skill may be evaluated in any procedures, but, for example, is evaluated using, as an evaluation item, a type of operation executed by a driver for one parking operation. In the present embodiment, as a type of operation, repeated turning of the steering wheel is set as an evaluation item. Specifically, the smaller the number of times the steering wheel is turned, the higher the evaluation of the level of parking skill is. As a modified example of the present embodiment, a level of a driver's parking skill may be evaluated using the length of time required for one parking operation as an evaluation item. Specifically, the shorter the time required for parking work is, the higher the evaluation of the level of parking skill may be. In the present embodiment, the level of parking skill is calculated by a grading evaluation, but for example, it may be calculated by a score obtained by scoring the number of times the steering wheel is turned or the length of time required for parking work, or by any method, such as an evaluation function.

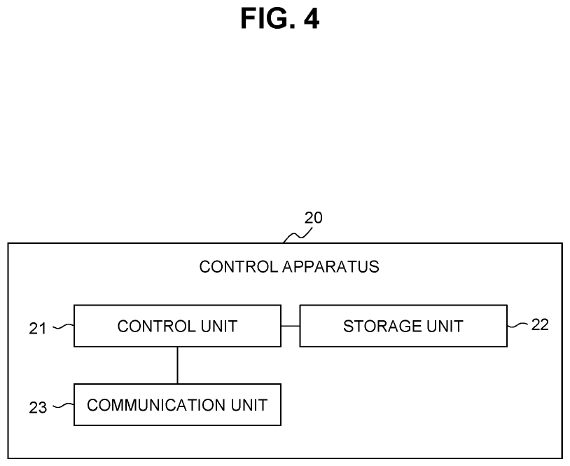

A configuration of the control apparatus 20 according to the present embodiment will be described with reference to FIG. 4.

The control apparatus 20 includes a control unit 21, a storage unit 22, and a communication unit 23.

The control unit 21 includes at least one processor, at least one programmable circuit, at least one dedicated circuit, or any combination thereof. The processor is a general-purpose processor, such as a central processing unit (CPU) or a graphics processing unit (GPU), or a dedicated processor specialized for a specific process. Examples of the programmable circuit include a field-programmable gate array (FPGA). Examples of the dedicated circuit include an application-specific integrated circuit (ASIC). The control unit 21 executes processing on an operation of the control apparatus 20 while controlling each unit of the control apparatus 20.

The storage unit 22 includes at least one semiconductor memory, at least one magnetic memory, at least one optical memory, or any combination thereof. Examples of the semiconductor memory include a random access memory (RAM) or a read-only memory (ROM). Examples of the RAM include a static random access memory (SRAM) or a dynamic random access memory (DRAM). Examples of the ROM include an electrically erasable programmable read-only memory (EEPROM). The storage unit 22 functions as, for example, a primary storage device, a secondary storage device, or a cache memory. The storage unit 22 stores information used for the operation of the control apparatus 20 and information obtained by the operation of the control apparatus 20. In the present embodiment, the table 50 is stored in the storage unit 22, but may be stored in an external storage and referred to by the control apparatus 20.

The communication unit 23 includes at least one communication interface. Examples of the communication interface include a LAN interface. The communication unit 23 receives the information used for the operation of the control apparatus 20 and transmits the information obtained by the operation of the control apparatus 20.

A function of the control apparatus 20 is implemented by executing a control program according to the present embodiment by a processor as the control unit 21. In other words, the function of the control apparatus 20 is implemented by software. The control program causes a computer to function as the control apparatus 20 by causing the computer to execute the operation of the control apparatus 20. In other words, the computer functions as the control apparatus 20 by executing the operation of the control apparatus 20 according to the control program.

A program can be stored on a non-transitory computer-readable medium. Examples of the non-transitory computer-readable medium include a flash memory, a magnetic recording device, an optical disk, a photo-magnetic recording medium, or a ROM. The program may be distributed, for example, by selling, transferring, or renting a portable medium, such as a Secure Digital (SD) card, a digital versatile disc (DVD), or a compact disc read-only memory (CD-ROM) that stores the program. The program may be distributed by storing the program in a storage of a server and transferring the program from the server to another computer. The program may be provided as a program product.

The computer temporarily stores, for example, the program stored in the portable medium or the program transferred from the server in the primary storage device. Then, the computer reads the program stored in the primary storage device by the processor, and executes processing according to the read program by the processor. The computer may read the program directly from the portable medium and execute the processing according to the program. The computer may sequentially execute the processing according to the received program each time the program is transferred from the server to the computer. The processing may be executed by a so-called application service provider (ASP) type service that implements the function only by an execution instruction and a result acquisition without transferring the program from the server to the computer. The program includes information used for processing by an electronic calculator and equivalent to the program. For example, data that is not a direct command to a computer but has a property of defining the processing of a computer corresponds to “information equivalent to the program”.

A part or all of the functions of the control apparatus 20 may be implemented by a programmable circuit or a dedicated circuit as the control unit 21. In other words, a part or all of the functions of the control apparatus 20 may be implemented by hardware.

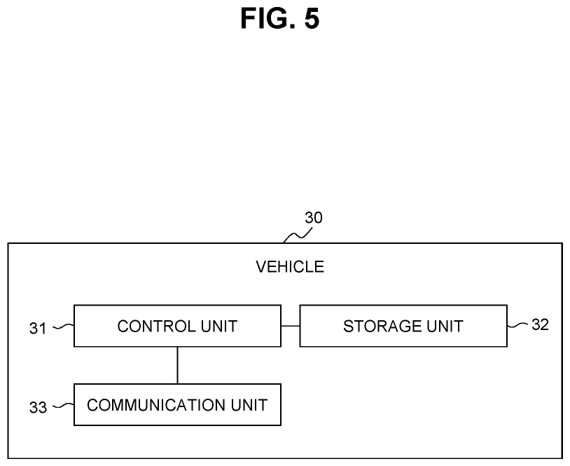

A configuration of the vehicle 30 according to the present embodiment will be described with reference to FIG. 5.

The vehicle 30 includes a control unit 31, a storage unit 32, and a communication unit 33.

The control unit 31 includes at least one processor, at least one programmable circuit, at least one dedicated circuit, at least one electronic control unit (ECU), or any combination thereof. The processor is a general-purpose processor, such as a CPU or a GPU, or a dedicated processor specialized for a specific process. Examples of the programmable circuit include an FPGA. Examples of the dedicated circuit include an ASIC. The control unit 31 executes processing on an operation of the vehicle 30 while controlling each functional component of the vehicle 30.

The storage unit 32 includes at least one semiconductor memory, at least one magnetic memory, at least one optical memory, or a combination of at least two thereof. Examples of the semiconductor memory include a RAM or a ROM. Examples of the RAM include an SRAM or a DRAM. Examples of the ROM include an EEPROM. The storage unit 32 functions as, for example, a primary storage device, a secondary storage device, or a cache memory. The storage unit 32 stores information used for the operation of the vehicle 30 and information obtained by the operation of the vehicle 30. In the present embodiment, the vehicle information D1 is stored in the storage unit 32, but may be stored in an external storage and referred to by the vehicle 30.

The communication unit 33 includes at least one communication interface. Examples of the communication interface include an interface corresponding to a mobile communication standard, such as Long-Term Evolution (LTE), the Fourth Generation (4G) standard, or the Fifth Generation (5G) standard, an interface corresponding to a near-field wireless communication standard, such as Bluetooth®, or a LAN interface. The communication unit 33 receives the information used for the operation of the vehicle 30 and transmits the information obtained by the operation of the vehicle 30. In the present embodiment, the communication unit 33 communicates with the control apparatus 20.

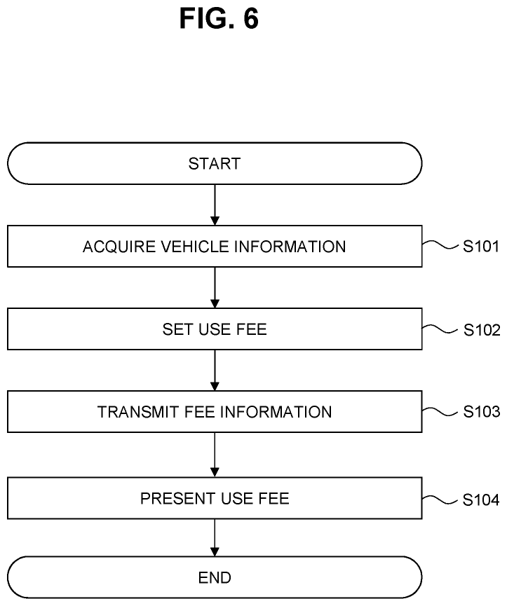

A configuration of a system 10 according to the present embodiment will be described with reference to FIG. 6. This operation corresponds to a control method according to the present embodiment.

In step S101, the communication unit 23 of the control apparatus 20 communicates with the vehicle 30. The control unit 21 of the control apparatus 20 acquires, via the communication unit 23, the vehicle information D1 indicating the attributes of the vehicle 30. Specifically, the vehicle information D1 is read from the storage unit 32 of the vehicle 30 by the control unit 31 of the vehicle 30 and transmitted to the control apparatus 20 via the communication unit 33 of the vehicle 30. The communication unit 23 of the control apparatus 20 receives the vehicle information D1 transmitted from the vehicle 30. The control unit 21 of the control apparatus 20 stores, in the storage unit 22, the vehicle information D1 received by the communication unit 23. In the present embodiment, the attributes of the vehicle 30 include the level of parking skill of the driver who drives the vehicle 30. As an example, it is assumed that the level of parking skill of the driver who drives the vehicle 30 is evaluated using the number of times the steering wheel is turned for one parking operation.

In step S102, the control unit 21 of the control apparatus 20 sets a use fee for each of the parking spaces in the parking lot 11 based on the vehicle information D1 acquired in step S101. The control unit 21 of the control apparatus 20 determines whether a level of a driver's parking skill indicated by the vehicle information D1 is equal to or higher than a threshold value. As described above, in the present embodiment, a level of a driver's parking skill is evaluated using repeated turning of the steering wheel as an evaluation item. Specifically, a level of a driver's parking skill is evaluated based on the number of times a driver turns the steering wheel in one parking operation. The number of times a driver turns the steering wheel in one parking operation may be, for example, the total number of times a driver turns the steering wheel in a plurality of parking operations executed in the past divided by the number of times of parking, that is, the average number of times a driver turns the steering wheel per parking operation. The smaller the number of times the steering wheel is turned in one parking operation, the higher the evaluation of the level of parking skill is. The level of parking skill may be evaluated as, for example, level 5 when the steering wheel is turned 1 time, level 4 when it is turned 2 times, level 3 when it is turned 3 times, level 2 when it is turned 4 times, and level 1 when it is turned 5 times or more. The threshold value may be any value, but is set to 3 in the present embodiment. Here, it is assumed that the average number of times the driver of the vehicle 30 turns the steering wheel in one parking operation is two times. Therefore, the parking skill of the driver of the vehicle 30 is evaluated as level 4. Since the parking skill of the driver of the vehicle 30 is level 4 and the threshold value is 3, the control unit 21 determines that the level of the driver's parking skill is equal to or higher than the threshold value.

Next, the control unit 21 of the control apparatus 20 sets a use fee for each of the parking spaces in the parking lot 11 according to a parking difficulty degree, which is evaluated for each of the parking spaces. Specifically, when the level of a driver's parking skill is equal to or higher than the threshold value, the control unit 21 sets the use fee to be lower as the parking difficulty degree is higher. For example, in the example of FIG. 2, the parking space PS2 with the difficulty score of 2 has the highest parking difficulty degree from among the parking spaces PS1 to PS5. The parking difficulty degree of the parking spaces PS4 and PS5 with the difficulty score of 1 is lower than that of the parking space PS2 and higher than that of the parking space PS1 with the difficulty score of 0. The parking difficulty degree of the parking space PS1 with the difficulty score of 0 is the lowest. Therefore, the control unit 21 sets the use fee of the parking space PS2 to be the lowest from among the use fees of the parking spaces PS1, PS2, PS4, PS5, excluding the parking space PS3 of which the parking difficulty degree is not evaluated. Further, the control unit 21 sets the use fees of the parking spaces PS4 and PS5 to be higher than that of the parking space PS2 and lower than that of the parking space PS1. Further, the control unit 21 sets the use fee of the parking space PS1 to be the highest. As a modified example of the present embodiment, instead of setting the parking fee for each parking space stepwise, only the use fee of the parking space with the highest parking difficulty degree may be set to be lower than those of the other parking spaces. On the other hand, when a level of a driver's parking skill is lower than the threshold value, the control unit 21 sets the use fee to be lower as the parking difficulty degree is lower. For example, in the example of FIG. 2, the parking space PS1 with the difficulty score of 0 has the lowest parking difficulty degree from among the parking spaces PS1 to PS5. The parking difficulty degree of the parking spaces PS4 and PS5 with the difficulty score of 1 is higher than that of the parking space PS1 with the difficulty score of 0 and lower than that of the parking space PS2 with the difficulty score of 2. The parking difficulty degree of the parking space PS2 with the difficulty score of 2 is the highest. Therefore, the control unit 21 sets the use fee of the parking space PS1 to be the lowest from among the use fees of the parking spaces PS1, PS2, PS4, PS5 excluding the parking space PS3 of which the parking difficulty degree is not evaluated. Further, the control unit 21 sets the use fees of the parking spaces PS4 and PS5 to be higher than that of the parking space PS1 and lower than that of the parking space PS2. Further, the control unit 21 sets the use fee of the parking space PS2 to be the highest. As a modified example of the present embodiment, instead of setting the parking fee for each parking space stepwise, only the use fee of the parking space with the lowest parking difficulty degree may be set to be lower than those of the other parking spaces.

In step S103, the control unit 21 of the control apparatus 20 transmits, via the communication unit 23, use fee information D2 indicating the use fee set in step S102 to the vehicle 30. The control unit 31 of the vehicle 30 receives, via the communication unit 33, the use fee information D2 transmitted from the control apparatus 20. Specifically, the control unit 31 of the vehicle 30 receives, via the communication unit 33, information transmitted from the control apparatus 20 and indicating the use fee set for each of the parking spaces PS1 to PS5 of the parking lot 11. The control unit 31 stores the received use fee information D2 in the storage unit 32.

In step S104, the control unit 31 of the vehicle 30 presents the use fee information D2 received in step S103 to the driver of the vehicle 30. Specifically, the control unit 31 reads out the use fee information D2 stored in the storage unit 32. The control unit 31 presents the driver of the vehicle 30 with the use fee of each of the parking spaces PS1, PS2, PS4, PS5, excluding the parking space PS3 at which the vehicle VH different from the vehicle 30 is already parked, from among the parking spaces PS1 to PS5 of the parking lot 11 indicated by the read use fee information D2. For example, the control unit 31 displays, on a display installed in the vehicle 30, the use fee, indicated by the use fee information D2, of each of the parking spaces PS1, PS2, PS4, PS5, excluding the parking space PS3 from among the parking spaces of the parking lot 11. The display may be, for example, a display of a car navigation device mounted on the vehicle 30, or a display audio mounted on the vehicle 30 and connected to a terminal, such as a driver's smartphone. The control unit 21 may present the use fee information D2 via the driver's terminal. In other words, the control unit 21 may present the use fee information D2 on the screen of the driver's terminal. The driver who sees the use fee indicated by the use fee information D2 is incentivized to park at a parking space with a lower use fee, and as a result, the vehicle 30 is guided to the parking space with the lowest use fee. Specifically, when a level of a driver's parking skill is equal to or higher than the threshold value, the vehicle 30 is guided to the parking space PS2. On the other hand, when a level of a driver's parking skill is lower than the threshold value, the vehicle 30 is guided to the parking space PS1.

As described above, in the present embodiment, the communication unit 23 of the control apparatus 20 communicates with the vehicle 30. The control unit 21 of the control apparatus 20 acquires, via the communication unit 23, the vehicle information D1 indicating the attributes of the vehicle 30. The control unit 21 sets a use fee of each of the plurality of parking spaces in the parking lot 11 based on the acquired vehicle information D1. The control unit 21 transmits, via the communication unit 23, the use fee information D2 indicating the set use fee to the vehicle 30.

With the present embodiment, the use fee for each parking space is set according to the attributes of the vehicle 30. As a result, it is possible to guide the vehicle 30 to a parking space according to the attributes of the vehicle 30, thereby promoting efficient use of a parking space.

As a modified example of the present embodiment, in step S103, the control unit 21 of the control apparatus 20 may further select at least one parking space from among the plurality of parking spaces according to a level of a driver's parking skill and transmit, via the communication unit 23, information prompting parking at the selected parking space to the vehicle 30. Specifically, the control unit 21 selects, as at least one parking space, a parking space of which the parking difficulty degree is higher as a level of parking skill of a driver is higher. In this modified example, when a level of a driver's parking skill is the highest level 5, the control unit 21 selects the parking space with the highest parking difficulty degree from among the plurality of parking spaces. In the example of FIG. 2, the control unit 21 selects the parking space PS2 from among the parking spaces PS1 to PS5 of the parking lot 11. Further, when a level of a driver's parking skill is the second highest level 4, the control unit 21 selects the parking space with the second highest parking difficulty degree from among the plurality of parking spaces. In the example of FIG. 2, the control unit 21 selects the parking space PS4 or PS5 from among the parking spaces PS1 to PS5 of the parking lot 11. At this time, the control unit 21 may select both the parking spaces PS4 and PS5. In that manner, the driver of the vehicle 30 can select the parking space that he/she prefers from among the parking spaces PS4 and PS5. Therefore, the driver can be given the freedom of selecting a parking space, and thus the degree of the driver's satisfaction can become higher. In step S104, when the parking space PS2 is selected, the control unit 21 further transmits, via the communication unit 23, a message stating “Please park at the parking space PS2” to the vehicle 30 as information prompting parking at the selected parking space. The vehicle 30 receives, via the communication unit 33, the message transmitted from the control apparatus 20. The vehicle 30 may display the received message on the display installed in the vehicle 30. Alternatively, instead of, or together with, the above message as the information prompting parking at the selected parking space, the control unit 21 may transmit a schematic diagram of the parking lot 11 in which the parking space PS2 is highlighted. The vehicle 30 may display the schematic diagram transmitted from the control apparatus 20 on the display installed in the vehicle 30.

With this modified example, by selecting different parking spaces according to a level of a driver's parking skill and prompting the driver to park at the selected parking space, the vehicle 30 can be directly guided to a parking space to be parked. Therefore, efficient use of a parking space can be further promoted.

As a modified example of the present embodiment, the attributes of the vehicle 30 may include the type of the vehicle 30, which is classified according to an energy source used by the vehicle 30. Specifically, the attributes of the vehicle 30 may include whether the type of the vehicle 30 is an EV or a gasoline vehicle. The energy source used by the vehicle 30 is not limited to electricity and gasoline, and may be any energy source as long as it can be supplied as an energy source for the vehicle 30. The energy source may be, for example, hydrogen. In this example, it is assumed that the vehicle 30 is a gasoline vehicle. In step S101, as an attribute of the vehicle 30, instead of the information indicating the level of the driver's parking skill, the control unit 21 receives, as the vehicle information D1, information indicating that the vehicle 30 is a gasoline vehicle. The control unit 21 determines the type of the vehicle 30 indicated by the acquired vehicle information D1. Specifically, the control unit 21 determines that the vehicle 30 is a gasoline vehicle.

In this modified example, at least one of the plurality of parking spaces of the parking lot 11 is provided with a supply facility CS that supplies a first energy source. In this example, the first energy source is electricity. In the example of FIG. 2, as a supply facility CS that supplies the first energy source, the parking space PS1 from among the parking spaces PS1 to PS5 of the parking lot 11 is provided with a charging facility CS1 that supplies electricity to an EV. The first energy source is not limited to electricity and may be any energy source.

In step S102, when the type of the vehicle 30 indicated by the vehicle information D1 is a type that uses a second energy source different from the first energy source, the control unit 21 of the control apparatus 20 sets the use fee according to whether the supply facility CS is provided in the parking space. Specifically, when the type of the vehicle 30 is a type that uses the second energy source, the control unit 21 sets the use fee of the parking space provided with the supply facility CS to be higher than that of the parking space not provided with the supply facility CS. In this example, the vehicle 30 is a gasoline vehicle, and the second energy source is gasoline. The second energy source is not limited to gasoline, and may be any energy source as long as it is different from the first energy source. Specifically, when the vehicle 30 is a gasoline vehicle, the control unit 21 sets the use fee of the parking space provided with the charging facility CS1 to be higher than that of the parking space not provided with the charging facility CS1. In the example of FIG. 2, the control unit 21 sets the use fee of the parking space PS1 provided with the charging facility CS1 to be higher than those of the parking spaces PS2 to PS5 not provided with the charging facility CS1. On the other hand, when the type of the vehicle 30 is a type that uses the first energy source, the control unit 21 sets the use fee of the parking space provided with the supply facility CS to be lower than that of the parking space not provided with the supply facility CS. Specifically, when the vehicle 30 is an EV, the control unit 21 sets the use fee of the parking space provided with the charging facility CS1 to be lower than that of the parking space not provided with the charging facility CS1. In the example of FIG. 2, the control unit 21 sets the use fee of the parking space PS1 provided with the charging facility CS1 to be lower than those of the parking spaces PS2 to PS5 not provided with the charging facility CS1.

When a vehicle using the second energy source different from the first energy source is parked at the parking space provided with the supply facility CS that supplies the first energy source, the supply facility CS is not used and is wasted. Specifically, when a gasoline vehicle that does not use the charging facility CS1 is parked at the parking space provided with the charging facility CS1 that supplies electricity, the charging facility CS1 is not used and is wasted. With this modified example, when the vehicle 30 is a gasoline vehicle, it is possible to restrict the gasoline vehicle from being parked at the parking space PS1 by setting the use fee of the parking space PS1 provided with the charging facility CS1 to be high. On the other hand, when the vehicle 30 is an EV, it is possible to promote the use of the parking space PS1 by the EV by setting the use fee of the parking space PS1 provided with the charging facility CS1 to be low. Therefore, efficient use of the charging facility CS1 is promoted. As a result, efficient use of a parking space can be promoted.

In this modified example, in step S103, the control unit 21 of the control apparatus 20 may select at least one parking space from among the plurality of parking spaces according to the type of the vehicle 30 and transmit, via the communication unit 23, information prompting parking at the selected parking space to the vehicle 30. Specifically, the control unit 21 may select at least one parking space from among the plurality of parking spaces according to whether the vehicle 30 is a gasoline vehicle or an EV. For example, when the vehicle 30 is a gasoline vehicle, the control unit 21 may select, as at least one parking space, at least one of the parking spaces PS2, PS4, PS5 in the example of FIG. 2. In this example, the control unit 21 selects the parking space PS4. The control unit 21 transmits, via the communication unit 23, a message stating “Please park the vehicle at the parking space PS4” to the vehicle 30 as information prompting parking at the selected parking space. On the other hand, when the vehicle 30 is an EV, the control unit 21 selects, as at least one parking space, the parking space PS1 in the example of FIG. 2. The control unit 21 transmits, via the communication unit 23, a message stating “Please park the vehicle at the parking space PS1” to the vehicle 30 as the information prompting parking at the selected parking space.

In step S104, the control unit 31 of the vehicle 30 presents the information transmitted from the control apparatus 20 to the driver of the vehicle 30. Specifically, when the vehicle 30 is a gasoline vehicle, the control unit 31 displays a message stating “Please park the vehicle at the parking space PS4” on the display installed in the vehicle 30. Alternatively, instead of or together with the above message as the information prompting parking at the selected parking space, the control unit 21 may display the schematic diagram of the parking lot 11 in which the parking space PS4 is highlighted. Alternatively, the control unit 21 may select, as at least one parking space, all of the parking spaces not provided with the supply facility CS and present them to the driver of the vehicle 30. Specifically, the control unit 21 may select all of the parking spaces PS2, PS4, PS5 in the example of FIG. 2 and display a message stating “Please park the vehicle at one of the parking spaces PS2, PS4, PS5” to the driver of the vehicle 30 on the display installed in the vehicle 30. In that manner, the driver of the vehicle 30 can select a parking space that he/she prefers from among the parking spaces PS2, PS4, PS5. Therefore, the driver is given the freedom of selecting a parking space, and thus the degree of the driver's satisfaction can become higher. On the other hand, when the vehicle 30 is an EV, the control unit 31 displays a message stating “Please park the vehicle at the parking space PS1” on the display installed in the vehicle 30. Alternatively, instead of or together with the above message as the information prompting parking at the selected parking space, the control unit 21 may display the schematic diagram of the parking lot 11 in which the parking space PS1 is highlighted. Alternatively, when a plurality of parking spaces is provided with supply facilities CS, the control unit 21 may select all of the parking spaces provided with the supply facilities CS and present them to the driver of the vehicle 30.

With this modified example, when the vehicle 30 is a gasoline vehicle, it is guided to the parking space not provided with the charging facility CS1, and thus the parking space provided with the charging facility CS1 is not occupied by the gasoline vehicle. Therefore, the charging facility CS1 is not used and is wasted. Further, when the vehicle 30 is an EV, it is guided to the parking space provided with the charging facility CS1, and thus the charging facility CS1 is efficiently used. Therefore, efficient use of a parking space in the parking lot 11 is promoted.

The present disclosure is not limited to the embodiments described above. For example, a plurality of blocks described in the block diagram may be integrated, or one block may be divided. Instead of executing the plurality of steps described in the flowchart in chronological order according to the description, they may be executed in parallel or in a different order according to the processing capacity of a device that executes each step, or as necessary. Other changes are also possible without departing from the scope of the present disclosure.

What is claimed is:

1. A control apparatus comprising:
a communication unit configured to communicate with a vehicle; and
a control unit configured to:
acquire, via the communication unit, vehicle information indicating attributes of the vehicle;
set a use fee for each of a plurality of parking spaces in a parking lot based on the acquired vehicle information; and
transmit, via the communication unit, fee information indicating the set use fee to the vehicle.

2. The control apparatus according to claim 1, wherein:
the vehicle is driven by a driver; and
the attributes of the vehicle include a level of the driver's parking skill.

3. The control apparatus according to claim 2, wherein the control unit is configured to set, when the level of the driver's parking skill indicated by the vehicle information is equal to or higher than a threshold value, the use fee according to a parking difficulty degree evaluated for each of the parking spaces.

4. The control apparatus according to claim 3, wherein the control unit is configured to set, when the level of the driver's parking skill is equal to or higher than the threshold value, the use fee to be lower as the parking difficulty degree is higher.

5. The control apparatus according to claim 3, wherein the control unit is configured to select, according to the level of the driver's parking skill, at least one parking space from among the parking spaces and transmit, via the communication unit, information prompting parking at the selected parking space to the vehicle.

6. The control apparatus according to claim 5, wherein the control unit is configured to select, as the at least one parking space, a parking space of which the parking difficulty degree is higher as the level of the driver's parking skill is higher.

7. The control apparatus according to claim 1, wherein the attributes of the vehicle include a kind of vehicle classified by an energy source used by the vehicle.

8. The control apparatus according to claim 7, wherein:
at least one of the parking spaces is provided with a supply facility that supplies a first energy source; and
the control unit is configured to set, when the kind of vehicle indicated by the vehicle information is a kind that uses a second energy source, the use fee according to whether the supply facility is provided, the second energy source being different from the first energy source.

9. The control apparatus according to claim 8, wherein the control unit is configured to set, when the kind of vehicle is the kind that uses the second energy source, a use fee of a parking space provided with the supply facility to be higher than a use fee of a parking space not provided with the supply facility.

10. The control apparatus according to claim 8, wherein the control unit is configured to select, according to the kind of vehicle, at least one parking space from among the parking spaces and transmit, via the communication unit, information prompting parking at the selected parking space to the vehicle.

11. The control apparatus according to claim 10, wherein the control unit is configured to select, when the kind of vehicle is the kind that uses the second energy source, as the at least one parking space, a parking space not provided with the supply facility.

12. A system comprising:
the control apparatus according to claim 1; and
a vehicle configured to communicate with the control apparatus.

13. A control method comprising:
communicating, by a control apparatus, with a vehicle;
acquiring, by the control apparatus, vehicle information indicating attributes of the vehicle;
setting, by the control apparatus, a use fee for each of a plurality of parking spaces in a parking lot based on the acquired vehicle information; and
transmitting, by the control apparatus, fee information indicating the set use fee to the vehicle.

14. The control method according to claim 13, wherein:
the vehicle is driven by a driver; and
the attributes of the vehicle include a level of the driver's parking skill.

15. The control method according to claim 14, wherein setting the use fee includes setting, when the level of the driver's parking skill indicated by the vehicle information is equal to or higher than a threshold value, the use fee according to a parking difficulty degree evaluated for each of the parking spaces.

16. The control method according to claim 15, wherein setting the use fee includes setting, when the level of the driver's parking skill is equal to or higher than the threshold value, the use fee to be lower as the parking difficulty degree is higher.

17. The control method according to claim 15, further comprising:
selecting, by the control apparatus, according to the level of the driver's parking skill, at least one parking space from among the parking spaces; and
transmitting, from the control apparatus, information prompting parking at the selected parking space to the vehicle.

18. The control method according to claim 13, wherein the attributes of the vehicle include a kind of vehicle classified by an energy source used by the vehicle.

19. The control method according to claim 18, wherein:
at least one of the parking spaces is provided with a supply facility that supplies a first energy source; and
setting the use fee includes setting, when the kind of vehicle indicated by the vehicle information is a kind that uses a second energy source, the use fee according to whether the supply facility is provided, the second energy source being different from the first energy source.

20. The control method according to claim 19, wherein setting the use fee includes setting, when the kind of vehicle is the kind that uses the second energy source, a use fee of the parking space provided with the supply facility to be higher than a use fee of a parking space not provided with the supply facility.
